(19) United States
(12) Patent Application Publication
(10) Pub. No.: US 2025/0163532 A1
(43) Pub. Date: May 22, 2025

(54) NON-ORIENTED ELECTRICAL STEEL SHEET AND METHOD FOR MANUFACTURING SAME

(71) Applicant: Hyundai Steel Company, Incheon (KR)

(72) Inventors: Yong Keun Ahn, Incheon (KR); Chun Ku Kang, Incheon (KR); Kyeong Sik Shin, Incheon (KR); Geun Ho Park, Incheon (KR)

(21) Appl. No.: 19/028,406

(22) Filed: Jan. 17, 2025

Related U.S. Application Data
(63) Continuation of application No. PCT/KR2023/010317, filed on Jul. 18, 2023.

(30) Foreign Application Priority Data
Jul. 20, 2022 (KR) 10-2022-0089538

(51) Int. Cl. C21D 9/46; C21D 8/12; C22C 38/00; C22C 38/02; C22C 38/04; C22C 38/06

(52) U.S. Cl. CPC C21D 9/46; C21D 8/1222; C21D 8/1233; C21D 8/1238; C21D 8/1272; C22C 38/002; C22C 38/02; C22C 38/04; C22C 38/06

(57) ABSTRACT

Provided is a non-oriented electrical steel sheet including silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities, wherein second-phase particles with an average diameter of 1.0 μm or more among second-phase particles constituting a microstructure of the non-oriented electrical steel sheet have a volume fraction of 60% or more, and wherein the non-oriented electrical steel sheet has a core loss (W_{10/400}) of 12.0 W/kg or less.

### CROSS-REFERENCE TO RELATED APPLICATIONS

This application is a continuation of International Application No. PCT/KR2023/010317 filed on Jul. 18, 2023, which claims under 35 U.S.C. § 119 (a) the benefit of Korean Patent Application No. 10-2022-0089538 filed on Jul. 20, 2022, the entire contents of which applications are incorporated by reference herein.

### TECHNICAL

The present disclosure relates to a non-oriented electrical steel sheet and a method of manufacturing the same, and more particularly, to a high-efficiency non-oriented electrical steel sheet and a method of manufacturing the same.

### BACKGROUND

Electrical steel sheets may be classified into oriented electrical steel sheets and non-oriented electrical steel sheets depending on their magnetic properties. Oriented electrical steel sheets exhibit excellent magnetic properties particularly in the rolling direction of the steel sheets because they are produced to be easily magnetized in the rolling direction, and thus are mostly used as cores for large, medium, and small-sized transformers which require low core loss and high magnetic permeability. On the other hand, non-oriented electrical steel sheets have uniform magnetic properties regardless of the direction of the steel sheets, and thus are commonly used as core materials for small motors, small power transformers, stabilizers, etc.

### SUMMARY

The present disclosure provides a high-efficiency non-oriented electrical steel sheet and a method of manufacturing the same.

However, the above description is an example, and the scope of the present disclosure is not limited thereto.

According to an aspect of the present disclosure, there is provided a non-oriented electrical steel sheet including silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities, wherein second-phase particles with an average diameter of 1.0 μm or more among second-phase particles constituting a microstructure of the non-oriented electrical steel sheet have a volume fraction of 60% or more, and wherein the non-oriented electrical steel sheet has a core loss (W_{10/400}) of 12.0 W/kg or less.

In a further aspect, there is provided a non-oriented electrical steel sheet consisting essentially of or consisting of: silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities, wherein second-phase particles with an average diameter of 1.0 μm or more among second-phase particles constituting a microstructure of the non-oriented electrical steel sheet have a volume fraction of 60% or more, and wherein the non-oriented electrical steel sheet has a core loss (W_{10/400}) of 12.0 W/kg or less.

Among the second-phase particles constituting the microstructure, second-phase particles with an average diameter of 1.0 μm or more and less than 2.0 μm may have a volume fraction of 20% or more, and second-phase particles with an average diameter of 2.0 μm or more may have a volume fraction of 38% or more.

The second-phase particles may include precipitate particles and inclusion particles.

The microstructure may have an average grain size of 80 μm to 160 μm.

According to another aspect of the present disclosure, there is provided a method of manufacturing a non-oriented electrical steel sheet, the method including: providing a steel material including silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities; hot rolling the steel material; first annealing the hot-rolled steel material; cold rolling the first-annealed steel material; and second annealing the cold-rolled steel material, wherein the hot rolling includes performing coiling at a coiling temperature (CT): 500° C. to 700° C. after the hot rolling, the first annealing includes performing annealing at 940° C. to 1110° C., and the second annealing includes performing annealing at 900° C. to 1100° C.

The hot rolling may be performed under conditions of a slab reheating temperature (SRT): 1110° C. to 1150° C. and a finishing delivery temperature (FDT): 800° C. to 900° C.

The hot-rolled steel material may have a thickness of 1.6 mm to 2.6 mm, and the cold-rolled steel material may have a thickness of 0.35 mm or less.

After the second annealing is performed, second-phase particles with an average diameter of 1.0 μm or more among second-phase particles constituting a microstructure of the non-oriented electrical steel sheet may have a volume fraction of 60% or more.

According to an embodiment of the present disclosure, a high-efficiency non-oriented electrical steel sheet and a method of manufacturing the same may be provided.

However, the scope of the present disclosure is not limited to the above effects.

As referred to herein, yield point and tensile stress (TS) can be measured using a commercially available tensile tester and according to the ISO standard ISO 6892-1, published in October 2009. As referred to herein, yield point refers to a lower yield point (MPa).

As referred to herein, grain size can be determined using imaging of a material or composition.

### BRIEF DESCRIPTION OF THE DRAWINGS

FIG. 1 is a flowchart of a method of manufacturing a non-oriented electrical steel sheet, according to an embodiment of the present disclosure.

### DETAILED DESCRIPTION

A method of manufacturing a non-oriented electrical steel sheet, according to an embodiment of the present disclosure, will now be described in detail. The terms used herein are selected based on their functions in the present disclosure, and their definitions should be made in the context of the entire specification.

Electrical steel sheets are generally classified into oriented electrical steel sheets and non-oriented electrical steel sheets. Oriented electrical steel sheets are mostly used in stationary machines such as transformers, and non-oriented electrical steel sheets are commonly used in rotating machines such as motors and generators. Currently, in response to global environmental issues, existing internal combustion engine vehicles are being rapidly replaced by hybrid electric vehicles (HEVs), electric vehicles (EVs), and hydrogen vehicles. The properties of electrical steel sheet materials may be evaluated by magnetic flux density and core loss. The magnetic flux density is mostly evaluated as B₅₀, and the core loss is generally evaluated as W_{15/50} but evaluated as W_{10/400} when high-frequency characteristics are required as in EVs. B₅₀ indicates the magnetic flux density at 5000 A/m, W_{15/50} indicates the core loss at 50 Hz and 1.5 T, and W_{10/400} indicates the core loss at 400 Hz and 1.0 T.

A representative method for improving the magnetic properties of an electrical steel sheet is to increase resistivity by adding elements such as silicon (Si), aluminum (Al), and manganese (Mn), or reduce material thickness. However, when the elements such as Si, Al, and Mn are added to increase resistivity, magnetic flux density is reduced, and rollability deteriorates to cause difficulties in material thickness reduction. In addition, the reduction in material thickness leads to reduced productivity and increased production costs.

Impurity elements such as carbon (C), sulfur(S), nitrogen (N), and titanium (Ti), which are unavoidably added in addition to the main alloying elements of the non-oriented electrical steel sheet, i.e., Si, Al, and Mn, bond to form fine precipitates and inclusions, and these second-phase particles hinder the movement of magnetic domains to deteriorate the magnetic properties. The smaller the second-phase particles, the more they hinder the movement of magnetic domains or suppress grain growth. Thus, controlling the size and fraction of second-phase particles is very critical.

According to an example of the technique for controlling inclusions or precipitates to improve the magnetic properties of the electrical steel sheet, the electrical steel sheet may be produced through slab reheating, hot rolling, hot-rolled plate annealing, cold rolling, and then final annealing. The above example is characterized in the difference between an average size of oxides and an average size of non-oxides among precipitates and in the addition of elements such as antimony (Sb) and tin (Sn). However, because the final magnetic properties are influenced by the amount and size of precipitates rather than the size ratio between non-oxides and oxides, it is not easy to consider the size ratio between oxides and non-oxides as being related to the magnetic properties. Although Sb and Sn may improve texture as grain boundary segregation elements, they suppress grain growth and deteriorate rolling quality.

According to another example of the technique for controlling inclusions or precipitates to improve the magnetic properties of the electrical steel sheet, zinc (Zn) is added to increase the cleanliness of steel and yttrium (Y) is added as a segregation element. However, the addition of Zn has limitations in controlling inclusions and, depending on the amount added, the formation of fine precipitates is promoted. Like Sb and Sn, Y is a grain boundary segregation element which suppresses grain growth and deteriorates rolling quality.

When making electrical steel sheets, the addition of impurities is controlled to be extremely low to minimize the formation of secondary phases, which badly affect the magnetic properties. However, unavoidable impurities may be added to form secondary phases and deteriorate the magnetic properties. The present disclosure proposes a method and product capable of improving the magnetic properties of a final product of non-oriented electrical steel sheet by controlling the size and volume fraction of second-phase particles in the final product through controlling coiling, hot annealing, and cold annealing process variables.

A slab is reheated to 1110° C. to 1150° C. and hot-rolled. In the hot rolling process, the slab is hot-rolled to 1.6 mm to 2.6 mm and then coiled. The coiling process is performed in a temperature range of 500° C. to 700° C. to minimize second-phase precipitation. The hot annealing process (e.g., annealing and pickling line (APL)) facilitates cold rolling by homogenizing the elongated structure formed inside the hot-rolled slab during the hot rolling process, and improves the magnetic properties by homogenizing the microstructure of the final product. However, when the hot annealing (e.g., APL) temperature condition is excessively high, fine precipitates may be formed and the magnetic properties may be hindered due to the redissolution of alloying elements. Thus, the hot annealing process is performed in a range of 940° C. to 1110° C. Lastly, the cold annealing process (e.g., annealing and coating line (ACL)) determines the quality of the final product by controlling the microstructure and precipitates of the cold-rolled product, and thus is performed in a range of 900° C. to 1100° C. The present disclosure provides an electrical steel sheet with improved magnetic properties by inducing a volume fraction of 60% or more of second-phase particles with a size of 1 μm or more in a final product, through controlling coiling temperature and hot annealing and cold annealing variables.

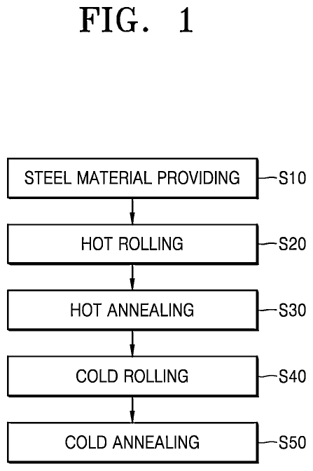

FIG. 1 is a flowchart of a method of manufacturing a non-oriented electrical steel sheet, according to an embodiment of the present disclosure.

Referring to FIG. 1, the non-oriented electrical steel sheet manufacturing method according to an embodiment of the present disclosure includes providing a steel material containing silicon (Si), manganese (Mn), and aluminum (Al) (S10); hot rolling the steel material (S20); first annealing the hot-rolled steel material (S30); cold rolling the first-annealed steel material (S40); and second annealing the cold-rolled steel material (S50).

### Steel Material Providing (S10)

The steel material provided for the hot rolling process is a steel material for manufacturing a non-oriented electrical steel sheet, and includes, for example, Si: 2.8 wt % to 3.8 wt %, Mn: 0.2 wt % to 0.5 wt %, Al: 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities.

The functions and contents of example components to which the non-oriented electrical steel sheet manufacturing method according to the technical features of the present disclosure is applicable will now be described.

### Si: 2.8 wt % to 3.8 wt %

Si is a major element added as a component for reducing core loss (or eddy current loss) by increasing resistivity. When the content of Si is less than 2.8 wt %, a desired low core loss value at high frequency is not easily achieved, and when the content increases, the magnetic permeability and magnetic flux density decrease. When the content of Si is greater than 3.8 wt %, brittleness increases to cause difficulties in cold rolling and reduce productivity.

### Mn: 0.2 wt % to 0.5 wt %

Mn increases resistivity together with Si and improves texture. When Mn is added more than 0.5 wt %, coarse MnS precipitates are formed to cause a deterioration in magnetic properties, such as a decrease in magnetic flux density. Furthermore, when the content of Mn is greater than 0.5 wt %, the decrease in core loss is small compared to the amount added, and cold rollability significantly deteriorates. When the content of Mn is less than 0.2 wt %, fine MnS precipitates may be formed to suppress grain growth. Thus, the content of Mn may be controlled in the range of 0.2 wt % to 0.5 wt %.

### Al: 0.5 wt % to 1.5 wt %

Al is a major element added as a component for reducing core loss (or eddy current loss) by increasing resistivity together with Si. Al serves to reduce a variation in magnetic properties by reducing magnetic anisotropy. Al induces AlN precipitation when combined with N. When the content of Al is less than 0.5 wt %, the above-described effect may not be easily expected and fine nitrides may be formed to increase the variation in magnetic properties, and when the content of Al is greater than 1.5 wt %, cold rollability deteriorates, and nitrides are excessively formed to reduce the magnetic flux density and deteriorate the magnetic properties.

C: More than 0 wt % and not More than 0.003 wt %

C is an element for increasing core loss by forming carbides such as TiC and NbC, and the less the better. The content of C is limited to 0.003 wt % or less. When the content of C is greater than 0.003 wt %, magnetic aging occurs to deteriorate the magnetic properties, and when the content of C is 0.003 wt % or less, magnetic aging is suppressed.

P: More than 0 wt % and not More than 0.015 wt %

P is an element for developing texture as a grain boundary segregation element. When the content of P is greater than 0.015 wt %, grain growth is suppressed, the magnetic properties deteriorate, and cold rollability is reduced due to the segregation effect.

S: More than 0 wt % and not More than 0.003 wt %

S increases core loss and suppresses grain growth by forming precipitates such as MnS and CuS, and thus the less the better. The content of S is limited to 0.003 wt % or less. When the content of S is greater than 0.003 wt %, the core loss increases.

N: More than 0 wt % and not More than 0.003 wt %

N increases core loss and suppresses grain growth by forming precipitates such as AlN, TiN, and NbN, and thus the less the better. The content of N is limited to 0.003 wt % or less. When the content of N is greater than 0.003 wt %, the core loss increases.

Ti: More than 0 wt % and not More than 0.003 wt %

Ti suppresses grain growth by forming fine precipitates such as TiC and TIN. Ti deteriorates the magnetic properties, and thus the less the better. The content of Ti is limited to 0.003 wt % or less. When the content of Ti is greater than 0.003 wt %, the magnetic properties deteriorate.

### Hot Rolling (S20)

The steel material with the above-described composition is hot-rolled. The step of hot rolling the steel material (S20) may be performed under conditions of a slab reheating temperature (SRT): 1110° C. to 1150° C. and a finishing delivery temperature (FDT): 800° C. to 900° C.

When the SRT is higher than 1150° C., precipitates such as C, S, and N in the slab may be redissolved and fine precipitates may be formed in subsequent rolling and annealing processes to suppress grain growth and deteriorate the magnetic properties. When the SRT is lower than 1110° C., the rolling load may increase and the final product may exhibit high core loss.

After the steel material is hot-rolled (S20), the hot-rolled plate may have a thickness of, for example, 1.6 mm to 2.6 mm. Because a reduction ratio of cold rolling increases and texture deteriorates when the hot-rolled plate is thick, the thickness may be controlled to 2.6 mm or less.

The hot-rolled steel material may be coiled under a condition of a coiling temperature (CT): 500° C. to 700° C. When the CT is lower than 500° C., the annealing effect of the steel material does not occur and thus grains do not grow, and when the CT is higher than 700° C., excessive oxidation occurs during cooling and thus picklability may deteriorate.

### First Annealing (S30)

The hot-rolled steel material may be first-annealed (S30). The first annealing is an annealing and pickling line (APL) process for annealing and pickling the hot-rolled plate, and may be understood as preliminary annealing or hot annealing.

The first annealing step (S30) includes an annealing process for increasing the temperature at a heating rate: 20° C./s or more, starting annealing at a temperature of 940° C. to 1110° C., and holding for 30 sec. to 180 sec. After the annealing process, the steel material may be cooled at a cooling rate of 20° C./s or more. After the cooling process, pickling may be further performed.

After the hot rolling, the hot-rolled plate is annealed to ensure microstructural uniformity and cold rollability. The first annealing temperature is controlled between 940° C. to 1110° C. to form a uniform microstructure by eliminating the elongated cast structure. When the first annealing temperature is excessively low (below 940° C.), the elongated cast structure may remain after the hot rolling to cause microstructural non-uniformity, and grains may be formed in small sizes to hinder cold rolling. On the other hand, when the first annealing temperature is excessively high (above 1110° C.), texture imbalance may occur in the final product to cause anisotropic properties.

### Cold Rolling (S40)

The first-annealed steel material is cold-rolled (S40). A reduction ratio of cold rolling may be 50% to 85%, and the cold-rolled steel material may have a thickness of 0.35 mm or less (more strictly, 0.25 mm or less). To provide rollability, the plate temperature may be increased to 100° C. to 200° C. for warm rolling.

### Second Annealing (S50)

The cold-rolled steel material may be second-annealed. The second annealing is an annealing and coating line (ACL) process for finally annealing the cold-rolled plate, and may be understood as cold annealing. The second annealing step (S50) may include performing annealing under conditions of a heating rate: 10° C./s or more, an annealing temperature: 900° C. to 1100° C., and a holding time: 30 sec. to 90 sec., and performing cooling under a condition of a cooling rate: 30° C./s or more.

The second annealing is performed with the cold-rolled plate obtained after the cold rolling. A temperature capable of achieving an optimal grain size is applied in consideration of core loss reduction and mechanical properties. Heating is performed under a mixed atmosphere condition to prevent surface oxidation and nitrification in the cold annealing. The surface is further smoothed using a mixed atmosphere of nitrogen and hydrogen. When the cold annealing temperature is lower than 900° C., fine grains may be formed to increase hysteresis loss, and when the cold annealing temperature is higher than 1100° C., coarse grains may be formed to increase eddy current loss.

Meanwhile, a coating process may be performed to form an insulating coating layer after the final cold annealing. By forming the insulating coating layer, punchability may be improved and insulation may be ensured. The insulating coating layer formed on and under the cold-rolled material may have a thickness of about 1 μm to 2 μm.

The non-oriented electrical steel sheet manufactured using the above-described method is a non-oriented electrical steel sheet including Si: 2.8 wt % to 3.8 wt %, Mn: 0.2 wt % to 0.5 wt %, Al: 0.5 wt % to 1.5 wt %, C: more than 0 wt % and not more than 0.003 wt %, P: more than 0 wt % and not more than 0.015 wt %, S: more than 0 wt % and not more than 0.003 wt %, N: more than 0 wt % and not more than 0.003 wt %, Ti: more than 0 wt % and not more than 0.003 wt %, and a balance of Fe and other unavoidable impurities. Second-phase particles with an average diameter of 1.0 μm or more among second-phase particles constituting a microstructure of the non-oriented electrical steel sheet have a volume fraction of 60% or more, and the non-oriented electrical steel sheet has a core loss (W_{10/400}) of 12.0 W/kg or less. The second-phase particles may include precipitate particles and inclusion particles.

Among the second-phase particles constituting the microstructure, second-phase particles with an average diameter of 1.0 μm or more and less than 2.0 μm may have a volume fraction of 20% or more, and second-phase particles with an average diameter of 2.0 μm or more may have a volume fraction of 38% or more.

The microstructure may have an average grain size of 80 μm to 160 μm. The finally manufactured non-oriented electrical steel sheet has mechanical properties of a yield point (YP): 400 MPa or more and a tensile strength (TS): 500 MPa or more.

Based on a non-oriented electrical steel sheet and a method of manufacturing the same, according to an embodiment of the present disclosure, by controlling second-phase particles with a size of 1 μm or more to a volume fraction of 60% or more through the control of coiling, APL, and ACL process variables, fine precipitates smaller than 1 μm, which hinder the movement of magnetic domains, may be minimized and thus a non-oriented electrical steel sheet with excellent magnetic properties may be manufactured.

### Test Examples

Test examples will now be described for better understanding of the present disclosure. However, the following test examples are merely to promote understanding of the present disclosure, and the present disclosure is not limited to thereto.

### 1. Composition of Samples

The present test examples provide samples with the alloying element composition (unit: wt %) of Table 1.

TABLE 1

| Si | Mn | Al | C | P | S | N | Ti | Bal. |
|---|---|---|---|---|---|---|---|---|
| 3.3 | 0.32 | 0.73 | 0.0025 | 0.0052 | 0.0014 | 0.0018 | 0.0011 | Fe |

Referring to Table 1, the composition of non-oriented electrical steel sheets according to the test examples satisfies Si: 2.8 wt % to 3.8 wt %, Mn: 0.2 wt % to 0.5 wt %, Al: 0.5 wt % to 1.5 wt %, C: more than 0 wt % and not more than 0.003 wt %, P: more than 0 wt % and not more than 0.015 wt %, S: more than 0 wt % and not more than 0.003 wt %, N: more than 0 wt % and not more than 0.003 wt %, Ti: more than 0 wt % and not more than 0.003 wt %, and a balance of Fe. A slab with the above-described composition was reheated to 1130° C. and hot-rolled under a condition of a FDT of 850° C., thereby producing a hot-rolled plate with a thickness of 2.0 mm.

### 2. Process Conditions and Property Evaluation

Table 2 shows a CT temperature and time, a first annealing temperature and time, and a second annealing temperature and time among process conditions of the present test examples. In the present test examples, coiling, first annealing, and second annealing were performed at various temperatures after the hot rolling. After the first annealing, cold rolling was performed to produce a cold-rolled plate with a thickness of 0.25 t, and the second annealing was performed. Then, a coating process was performed to manufacture a final product. The final annealing was performed in a mixed atmosphere of 30% hydrogen-70% nitrogen. In this case, a heating rate of 20° C./s and a cooling rate of 30° C./s were used. In Table 2, CT temperature indicates a coiling temperature, CT time indicates a holding time for which the steel material is maintained at the coiling temperature after being coiled, APL temperature indicates a first annealing temperature, APL time indicates a first annealing holding time, ACL temperature indicates a second annealing temperature, and ACL time indicates a second annealing holding time.

TABLE 2

| | CT | | APL | | ACL | |
|---|---|---|---|---|---|---|
| | Temper- | CT | Temper- | APL | Temper- | ACL |
| | ature | Time | ature | Time | ature | Time |
| | (° C.) | (min) | (° C.) | (sec) | (° C.) | (sec) |
| Embodiment 1 | 600 | 120 | 975 | 60 | 1000 | 60 |
| Comparative | 720 | 120 | 975 | 60 | 1000 | 60 |
| Example 1 | | | | | | |
| Comparative | 800 | 120 | 975 | 60 | 1000 | 60 |
| Example 2 | | | | | | |
| Comparative | 600 | 120 | 900 | 60 | 1000 | 60 |
| Example 3 | | | | | | |
| Embodiment 1 | 600 | 120 | 975 | 60 | 1000 | 60 |
| Embodiment 2 | 600 | 120 | 1000 | 60 | 1000 | 60 |
| Embodiment 3 | 600 | 120 | 1100 | 60 | 1000 | 60 |
| Comparative | 600 | 120 | 1150 | 60 | 1000 | 60 |
| Example 4 | | | | | | |
| Comparative | 600 | 120 | 1200 | 60 | 1000 | 60 |
| Example 5 | | | | | | |
| Comparative | 600 | 120 | 975 | 60 | 850 | 60 |
| Example 6 | | | | | | |
| Embodiment 4 | 600 | 120 | 975 | 60 | 950 | 60 |
| Embodiment 1 | 600 | 120 | 975 | 60 | 1000 | 60 |
| Embodiment 5 | 600 | 120 | 975 | 60 | 1050 | 60 |
| Embodiment 6 | 600 | 120 | 975 | 60 | 1100 | 60 |
| Comparative | 600 | 120 | 975 | 60 | 1150 | 60 |
| Example 7 | | | | | | |
| Comparative | 600 | 120 | 975 | 60 | 1200 | 60 |
| Example 8 | | | | | | |

Referring to Table 2, Embodiment 1 and Comparative Examples 1 and 2 use the same first annealing and second annealing conditions, but different coiling conditions. Embodiments 1, 2, and 3, and Comparative Examples 3, 4, and 5 use the same coiling and second annealing conditions, but different first annealing conditions. Embodiments 1, 4, 5, and 6, and Comparative Examples 6, 7, and 8 use the same coiling and first annealing conditions, but different second annealing conditions. Embodiments 1, 2, 3, 4, 5, and 6 satisfy a CT: 500° C. to 700° C., a first annealing temperature: 940° C. to 1110° C., and a second annealing temperature: 900° C. to 1100° C.

On the other hand, Comparative Example 1 exceeds and does not satisfy the CT: 500° C. to 700° C., Comparative Example 2 exceeds and does not satisfy the CT: 500° C. to 700° C., Comparative Example 3 falls below and does not satisfy the first annealing temperature: 940° C. to 1110° C., Comparative Example 4 exceeds and does not satisfy the first annealing temperature: 940° C. to 1110° C., Comparative Example 5 exceeds and does not satisfy the first annealing temperature: 940° C. to 1110° C., Comparative Example 6 falls below and does not satisfy the second annealing temperature: 900° C. to 1100° C., and Comparative Examples 7 and 8 exceed and do not satisfy the second annealing temperature: 900° C. to 1100° C.

Table 3 shows a grain size, second-phase particle volume fractions, and a core loss (W_{10/400}) of the non-oriented electrical steel sheets manufactured according to the present test examples.

TABLE 3

| | | A: 1 μm to 2 μm | B: ≥2 μm | | |
|---|---|---|---|---|---|
| | Grain | Second-Phase | Second-Phase | | |
| | Size | Volume | Volume | Total | W_{10/400} |
| | (μm) | Fraction (%) | Fraction (%) | (A + B) | (W/kg) |
| Embodiment 1 | 130.3 | 20.4 | 45.1 | 65.5 | 11.1 |
| Comparative | 133.7 | 14.8 | 24.5 | 39.3 | 12.5 |
| Example 1 | | | | | |
| Comparative | 133.7 | 11.4 | 20.2 | 31.6 | 12.8 |
| Example 2 | | | | | |
| Comparative | 106.5 | 16.8 | 25.8 | 42.6 | 12.1 |
| Example 3 | | | | | |
| Embodiment 1 | 130.3 | 20.4 | 45.1 | 65.5 | 11.1 |
| Embodiment 2 | 145.2 | 22.2 | 38.3 | 60.5 | 11.4 |
| Embodiment 3 | 148.2 | 22.6 | 38.9 | 61.5 | 11.6 |
| Comparative | 142.6 | 16.9 | 27.2 | 44.1 | 12.7 |
| Example 4 | | | | | |
| Comparative | 140.3 | 14.3 | 22.8 | 37.1 | 13 |
| Example 5 | | | | | |
| Comparative | 73.4 | 13.3 | 24.8 | 38.1 | 12.6 |
| Example 6 | | | | | |
| Embodiment 4 | 112.3 | 22.2 | 38.8 | 61 | 11.8 |
| Embodiment 1 | 130.3 | 20.4 | 45.1 | 65.5 | 11.1 |
| Embodiment 5 | 142 | 20.2 | 45 | 65.2 | 11.5 |
| Embodiment 6 | 158.2 | 22.1 | 42.1 | 64.2 | 11.8 |
| Comparative | 180.6 | 14.5 | 24.2 | 38.7 | 13.3 |
| Example 7 | | | | | |
| Comparative | 211.3 | 13.8 | 22.7 | 36.5 | 13.2 |
| Example 8 | | | | | |

Referring to Table 3, Embodiments 1, 2, 3, 4, 5, and 6 satisfy all of an average grain size: 80 μm to 160 μm, a volume fraction (A) of second-phase particles with an average diameter of 1.0 μm or more and less than 2.0 μm among the second-phase particles constituting the microstructure: 20% or more, a volume fraction (B) of second-phase particles with an average diameter of 2.0 μm or more among the second-phase particles constituting the microstructure: 38% or more, a volume fraction (A+B) of second-phase particles with an average diameter of 1.0 μm or more among the second-phase particles constituting the microstructure: 60% or more, and a core loss (W_{10/400}): 12.0 W/kg or less. For example, Embodiments 1, 2, 3, 4, 5, and 6 satisfy a volume fraction (A) of second-phase particles with an average diameter of 1.0 μm or more and less than 2.0 μm among the second-phase particles constituting the microstructure: 20% or more and 30% or less, a volume fraction (B) of second-phase particles with an average diameter of 2.0 μm or more among the second-phase particles constituting the microstructure: 38% or more and 50% or less, and a volume fraction (A+B) of second-phase particles with an average diameter of 1.0 μm or more among the second-phase particles constituting the microstructure: 60% or more and 70% or less.

On the other hand, Comparative Examples 1, 2, 3, 4, 5, 6, 7, and 8 fall below and do not satisfy the volume fraction (A+B) of second-phase particles with an average diameter of 1.0 μm or more among the second-phase particles constituting the microstructure: 60% or more, Comparative Example 6 falls below and does not satisfy the average grain size: 80 μm to 160 μm, and Comparative Examples 7 and 8 exceed and do not satisfy the average grain size: 80 μm to 160 μm.

According to the above-described test examples, a product in which second-phase particles with an average diameter of 1.0 μm or more satisfy a volume fraction of 60% or more to achieve excellent core loss properties is ensured by controlling process variables based on reference conditions.

Unlike this, for example, according to Comparative Examples 1, 2, 4, 5, 7, and 8, because the process temperature is relatively high and thus precipitate elements are redissolved and then cooled during the process to form fine precipitates, the volume fraction of second-phase particles with an average diameter of 1.0 μm or more decreases and the core loss properties deteriorate.

According to Comparative Examples 3 and 6, because the process temperature is relatively low, the grain size is relatively small, the volume fraction of second-phase particles with an average diameter of 1.0 μm or more decreases, and the core loss properties deteriorate.

The test examples of the present disclosure have verified above that, by controlling second-phase particles with a size of 1 μm or more to a volume fraction of 60% or more through the control of coiling, APL, and ACL process variables, fine precipitates smaller than 1 μm, which hinder the movement of magnetic domains, may be minimized and thus a non-oriented electrical steel sheet with excellent magnetic properties may be manufactured.

While the present disclosure has been particularly shown and described with reference to embodiments thereof, it will be understood by one of ordinary skill in the art that various changes in form and details may be made therein without departing from the scope of the present disclosure as defined by the following claims.

1. A non-oriented electrical steel sheet comprising silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities,
wherein second-phase particles with an average diameter of 1.0 μm or more among second-phase particles constituting a microstructure of the non-oriented electrical steel sheet have a volume fraction of 60% or more, and
wherein the non-oriented electrical steel sheet has a core loss (W_{10/400}) of 12.0 W/kg or less.

2. The non-oriented electrical steel sheet of claim 1, wherein, among the second-phase particles constituting the microstructure, second-phase particles with an average diameter of 1.0 μm or more and less than 2.0 μm have a volume fraction of 20% or more, and second-phase particles with an average diameter of 2.0 μm or more have a volume fraction of 38% or more.

3. The non-oriented electrical steel sheet of claim 1, wherein the second-phase particles comprise precipitate particles and inclusion particles.

4. The non-oriented electrical steel sheet of claim 1, wherein the microstructure may have an average grain size of 80 μm to 160 μm.

5. A method of manufacturing a non-oriented electrical steel sheet, the method comprising:
providing a steel material comprising silicon (Si): 2.8 wt % to 3.8 wt %, manganese (Mn): 0.2 wt % to 0.5 wt %, aluminum (Al): 0.5 wt % to 1.5 wt %, carbon (C): more than 0 wt % and not more than 0.003 wt %, phosphorus (P): more than 0 wt % and not more than 0.015 wt %, sulfur(S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities;
hot rolling the steel material;
first annealing the hot-rolled steel material;
cold rolling the first-annealed steel material; and
second annealing the cold-rolled steel material,
wherein the hot rolling comprises performing coiling at a coiling temperature (CT): 500° C. to 700° C. after the hot rolling, the first annealing comprises performing annealing at 940° C. to 1110° C., and the second annealing comprises performing annealing at 900° C. to 1100° C.

6. The method of claim 5, wherein the hot rolling is performed under conditions of a slab reheating temperature (SRT): 1110° C. to 1150° C. and a finishing delivery temperature (FDT): 800° C. to 900° C.

7. The method of claim 5, wherein the hot-rolled steel material has a thickness of 1.6 mm to 2.6 mm, and the cold-rolled steel material has a thickness of 0.35 mm or less.

8. The method of claim 5, wherein, after the second annealing is performed, second-phase particles with an average diameter of 1.0 μm or more among second-phase particles constituting a microstructure of the non-oriented electrical steel sheet have a volume fraction of 60% or more.
